(19) United States
(12) Patent Application Publication
(10) Pub. No.: US 2012/0061504 A1
(43) Pub. Date: Mar. 15, 2012

(54) TRANSPORTING AND INSTALLING FLEXIBLE PIPE

(76) Inventor: Michael Powell, Houston, TX (US)

(21) Appl. No.: 13/320,862

(22) PCT Filed: May 19, 2010
(86) PCT No.: PCT/GB10/50817

§ 371 Date: Nov. 16, 2011

Related U.S. Application Data
(60) Provisional application No. 61/180,766, filed on May 22, 2009.

(51) Int. Cl. B65H 49/20; F16L 1/00; E21B 19/22; B65H 49/34; B65H 49/24

(52) U.S. Cl. 242/564; 242/595; 242/595.1; 242/566

(57) ABSTRACT

A method and apparatus are disclosed for transporting and/or unloading and/or installing a flexible pipe. The apparatus comprises at least one support member for supporting a reel member carrying a wound flexible pipe and a plurality of reel rim guide elements for locating the reel member at a desired location with respect to the support member.

The present invention relates to flexible pipes which may be used to convey fluids such as production fluids. In particular, but not exclusively, the present invention relates to a method and apparatus for transporting reels of flexible pipe and/or installing flexible pipe at a desired location.

Traditionally flexible pipe is utilised to transport production fluids, such as oil and/or gas and/or water, from one location to another. Flexible pipe is particularly useful in connecting a sub-sea location to a further sub-sea location or a sea level location. Flexible pipe is generally formed as an assembly of a length of flexible pipe body and one or more end fittings. The pipe body is typically formed as a composite of tubular layers of material that form a fluid and pressure containing conduit. The pipe structure allows large deflections without causing bending stresses that impair the pipe's functionality over a desired lifetime. The pipe body is generally, but not necessarily, built up as a composite structure including metallic and polymer layers. Flexible pipe may be utilised as a flowline over land and/or at a sub-sea location. Flexible pipe may also be used as a jumper or riser.

In view of the potentially long lengths of flexible pipe utilized from time to time transportation of flexible pipe from one location to another has, in the past, been a complex and thus costly process. Additionally installation of flexible pipe at a desired location has been a costly, time consuming and potentially hazardous operation. A solution for transporting flexible pipe and/or installing flexible pipe has been to wind lengths of flexible pipe in a spool arrangement around a reel. Large diameter reels having a diameter of many metres have been utilized much like cotton thread is wound around a cotton reel. Under roller drive bases have been used extensively for the handling and rotation of such reels on shore. Such roller drive bases are relatively low cost for the size and weight of reels that can be rotated. Many manufacturers of subsea flexible lines utilize such roller drive bases for onshore activity.

A roller driver base typically includes parallel pairs of driven rollers spaced apart so that a reel sits on the rollers. By driving one or more of the rollers a reel can be made to rotate with a flexible pipe wound in a spooled configuration being unwound at a target location or indeed wound onto the reel prior to transport.

Although suitable for onshore applications, roller drive bases have generally been found to be unacceptable for offshore applications following a number of notable incidents where reels have either been pulled off or just fallen off the driver bases.

As a result a preferred methodology for transporting and installing spooled flexible pipe has made use of a hub drive system. The principle of such a system is that a reel is supported on a pair of reel cradles which are welded to the deck of a vessel used to transport the flexible pipe to a desired location. The reel is normally chained to the deck during transport. When required, drive towers located at either side of a reel are operated to engage the hub of the reel and then lift the reel clear of the cradles into a position suitable for rotation. For operation with a number of reels the towers are mounted on drive rails which allow the system to move along a prearranged row of reels and engaging with each one in turn.

Although such equipment is widely adopted for offshore applications there are a number of serious shortcomings with such systems. Notably the width across the reel and the drive towers is typically twice the width of the reel alone thus meaning that such a system takes up a great deal of deck space. In large vessels such deck space is at a premium.

Another notable problem is that reel fastenings to the deck have to be removed while the towers are moved into place and engage with a reel. This is time consuming, potentially dangerous, and is prone to user error.

A still further problem is that when multiple reels are transported on a vessel these have to be aligned with the drive rails used to locate drive towers. This limits the deck layout options for a vessel.

A still further problem is that once a reel is lifted the weight of the reel is transferred to the tower drive rails requiring the drive rail foundations to have more strength than the reel foundations over the full length. Supplying such strength naturally has a cost implication.

A still further problem is that the hub adaptors are a loose fit into the reel due to relatively large reel manufacturing tolerances. The high centre of gravity of the reel and the loose connection can occasionally cause the towers to rotate laterally at the connection to the deck. This imposes substantial vertical loads at the inner and outer extremities of the rails (commonly called “racking”). These twisting forces can cause failure which can in turn potentially cause injury to personnel or delay the transportation and/or installation process.

It is an aim of the present invention to at least partly mitigate the above-mentioned problems.

It is an aim of certain embodiments of the present invention to provide a drive system which can be rapidly loaded or reloaded with a full or partially full reel of flexible pipe and which may optionally also be operated to spool the flexible pipe on or off the reel using a system of driven friction rollers bearing on the reel.

It is an aim of certain embodiments of the present invention to provide a method and apparatus which can be safely operated from a vessel at sea.

It is an aim of certain embodiments of the present invention to provide a space efficient system for loading/reloading and unloading reels of flexible pipe which proves versatile within the space constraints of the plan size of a reel.

According to a first aspect of the present invention there is provided apparatus for transporting and/or installing a flexible pipe, comprising:
at least one support member for supporting a reel member carrying a wound flexible pipe: and
a plurality of reel rim guide elements for locating the reel member at a desired location with respect to the support member.
According to a second aspect of the present invention there is provided a method of transporting a flexible pipe, comprising the steps of:
   on a deck or in a hold of a vessel, supporting a reel member carrying a wound flexible pipe with at least one support member; and
      as the vessel moves, maintaining the reel member at a desired location with respect to the support member via a plurality of reel rim guide elements.
According to a third aspect of the present invention there is provided a method of installing a flexible pipe, comprising the steps of:
   rotating a rim of a reel member carrying a wound flexible pipe by driving at least one driven roller element supporting the reeled member.

Certain embodiments of the present invention provide a reduced cost per drive system for offshore use. Certain embodiments of the present invention provide a decreased space requirement for transporting and/or installing flexible pipe.

Certain embodiments provide improved rigidity and low load spread across the underside of a reel and reduce or wholly eliminate bending moments normally associated with hub drive systems.

Certain embodiments of the present invention provide a lower centre of gravity during drive operations and additionally or alternatively require relatively few or no fastenings to secure the reel during sea transport.

Certain embodiments of the present invention provide an increased packing density for multiple reels on a vessel thus providing much greater deck layout flexibility.

Embodiments of the present invention will now be described hereinafter, by way of example only, with reference to the accompanying drawings in which:

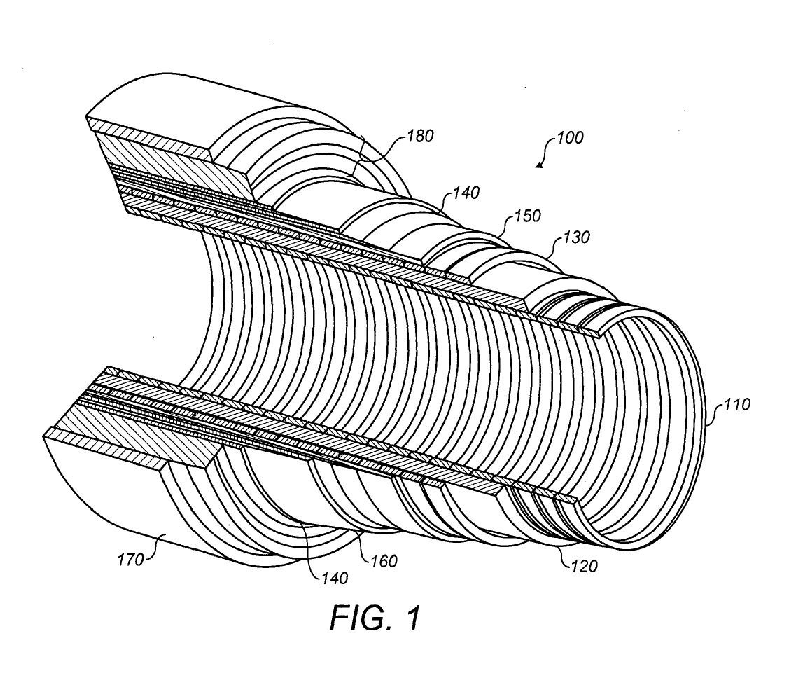

FIG. 1 illustrates flexible pipe body;

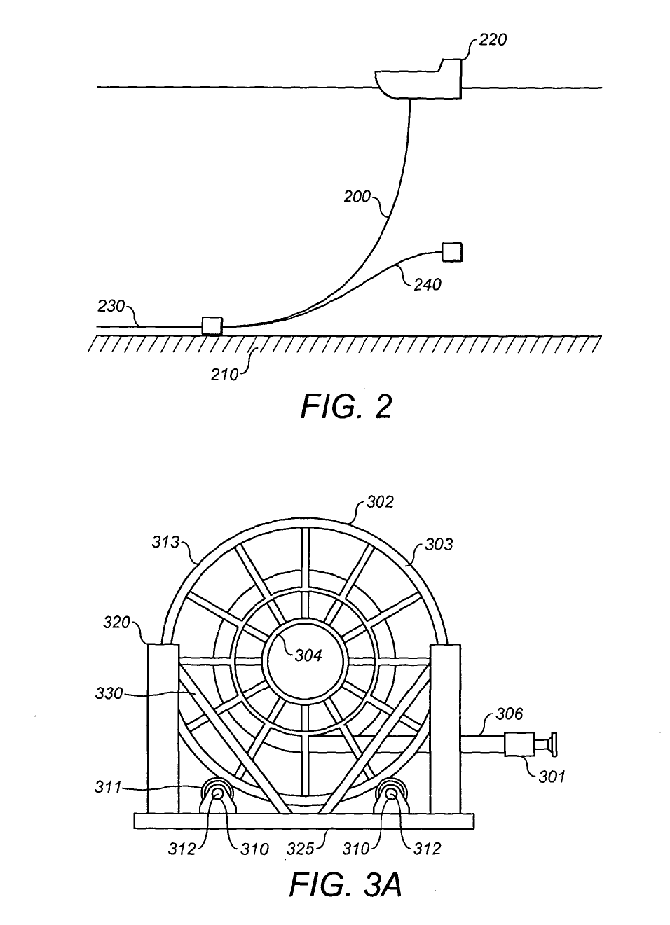

FIG. 2 illustrates a riser, flowline and jumper;

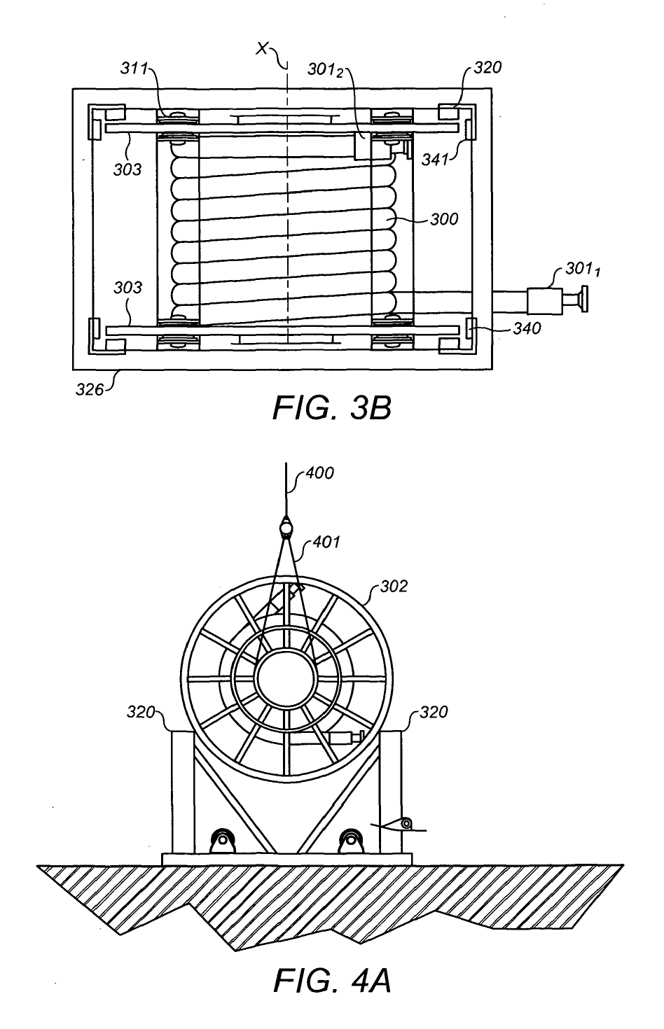

FIGS. 3A and 3B illustrate a support for a reel;

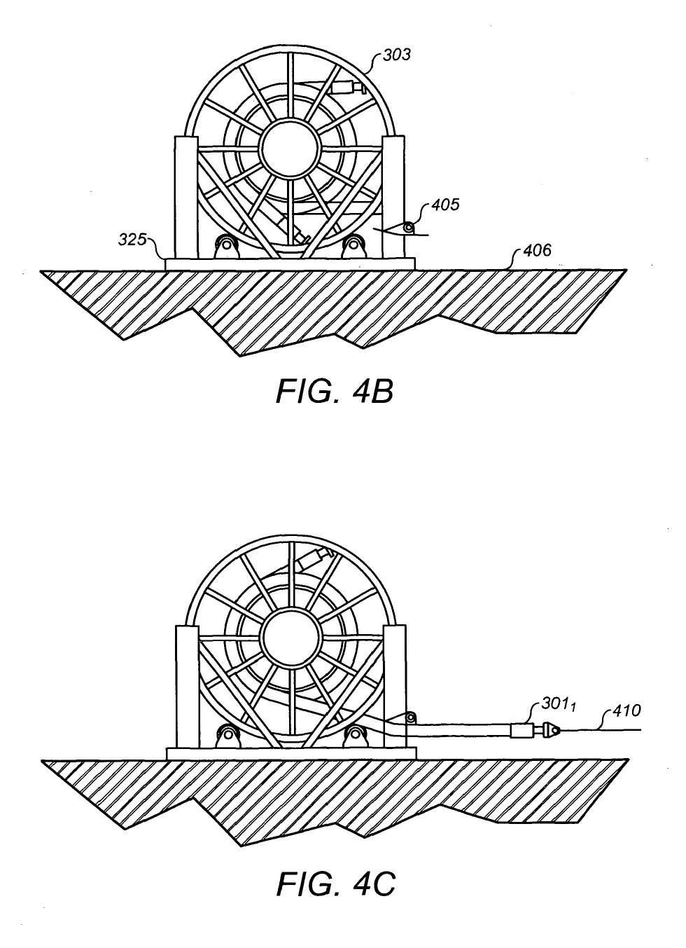

FIGS. 4a, 4B and 4C illustrate an operating sequence for loading/uploading a preloaded reel of flexible pipe;

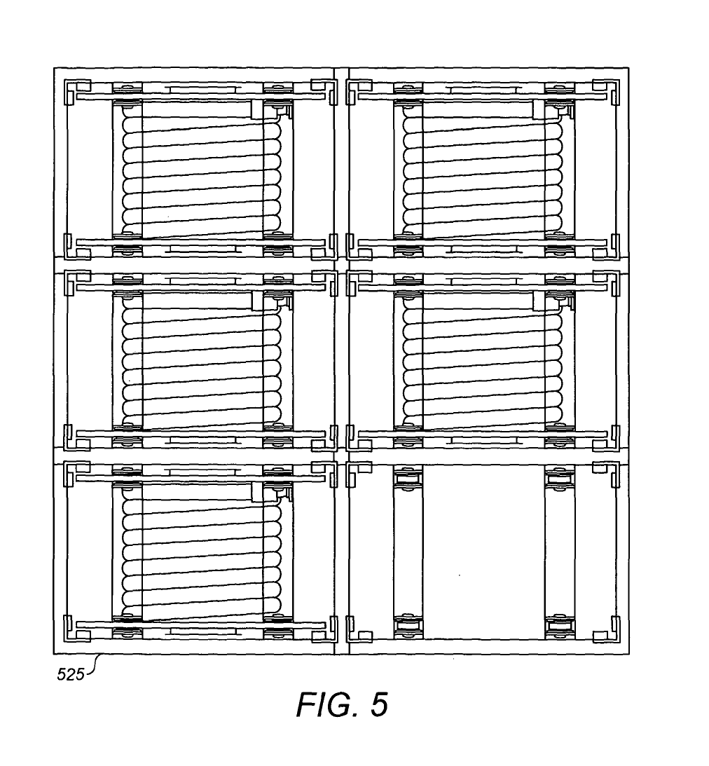

FIG. 5 illustrates the sharing of structural members between adjacent supporting frames;

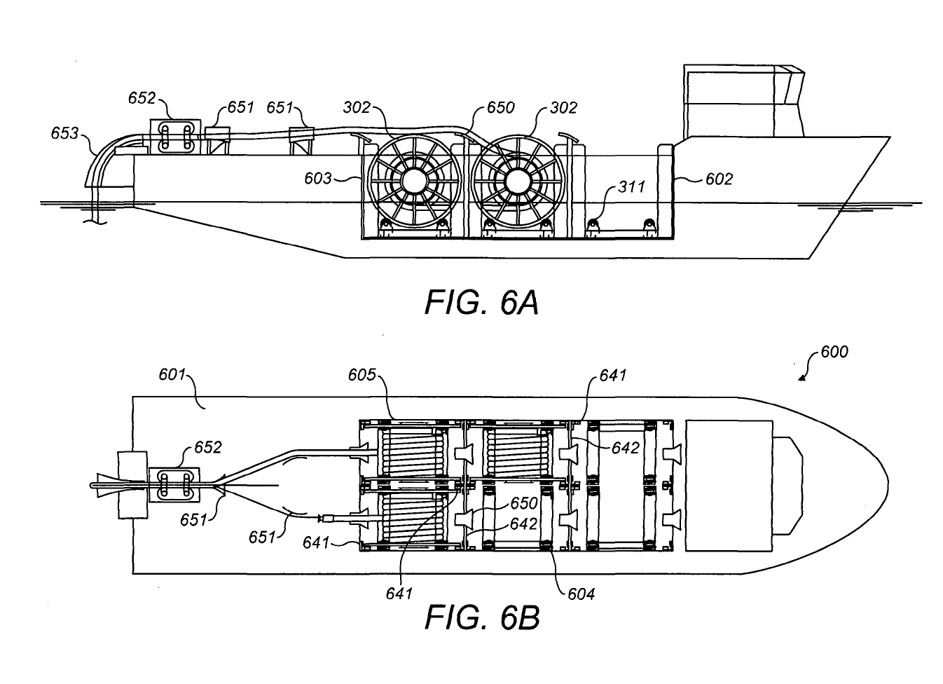

FIGS. 6A and 6B illustrate a vessel used for transporting flexible pipe and installing flexible pipe at a desired location;

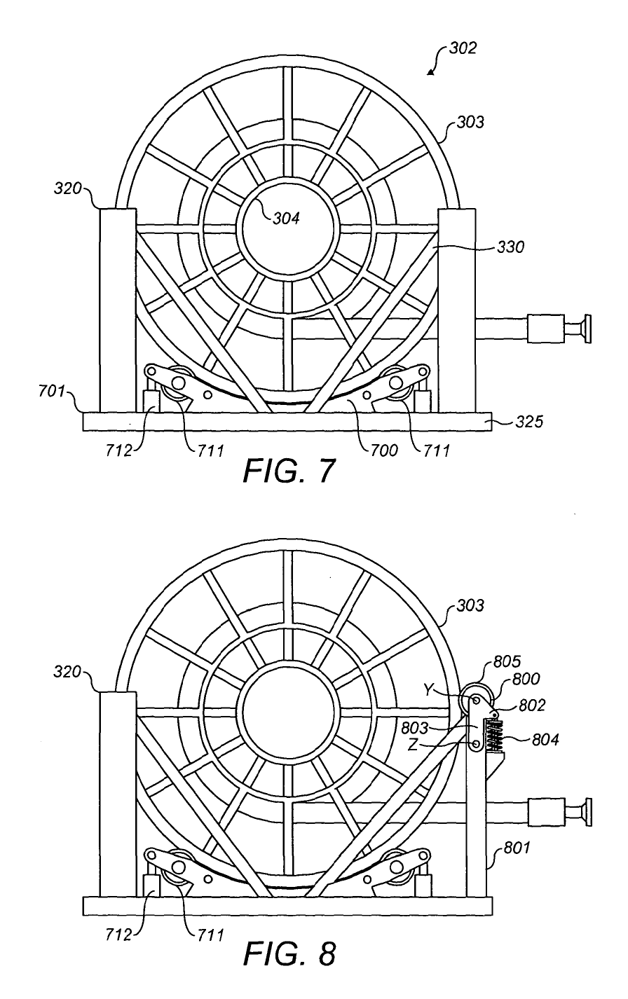

FIG. 7 illustrates an alternative embodiment for supporting and rotating a reel;

FIG. 8 illustrates an alternative embodiment for supporting and rotating a reel; and

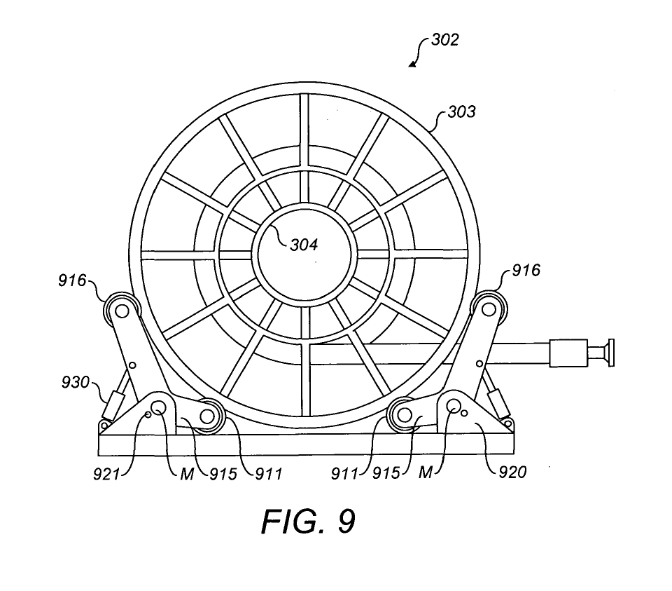

FIG. 9 illustrates an alternative embodiment for supporting and rotating a reel.

In the drawings like reference numerals refer to like parts.

Throughout this specification reference will be made to a flexible pipe. It will be understood that one type of flexible pipe is an assembly of a portion of pipe body and one or more end fittings in each of which an end of the pipe body is terminated. FIG. 1 illustrates how a pipe body 100 is formed in accordance with an embodiment of the present invention from a composite of layered materials that form a pressure-containing conduit. Although a number of particular layers are illustrated in FIG. 1, it is to be understood that the present invention is broadly applicable to composite pipe body structures including two or more layers. It is to be further noted that the layer thicknesses are shown for illustrative purposes only.

As illustrated in FIG. 1, the pipe body includes an innermost carcass layer 110 and a pressure sheath 120. The carcass 110 provides an interlocked metallic construction that can be used as the innermost layer to prevent, totally or partially, collapse of an internal pressure sheath 120 due to pipe decompression, external pressure, tensile armour pressure and mechanical crushing loads. It will be appreciated that embodiments of the present invention are applicable to ‘smooth bore’ as well as such ‘rough bore’ applications.

The internal pressure sheath 120 acts as a fluid retaining layer and typically comprises a polymer layer that ensures internal-fluid integrity. It is to be understood that this layer 120 may itself comprise a number of sub-layers. It will be appreciated that when the optional carcass 110 layer is utilised the internal pressure sheath 120 is often referred to as a barrier layer. In operation without such a carcass 110 (so-called smooth-bore operation) the internal pressure sheath 120 may be referred to as a liner.

A pressure armour layer 130 is formed over the internal pressure sheath 120 and is a structural layer with a lay angle close to 90° that increases the resistance of the flexible pipe body 100 to internal and external pressure and mechanical crushing loads. The armour layer 130 also structurally supports the internal-pressure sheath 120 and typically consists of an interlocked metallic construction.

The flexible pipe body 100 may also include one or more layers of tape 140 and a first tensile armour layer 150 and second tensile armour layer 160. Each tensile armour layer 150, 160 is a structural layer with a lay angle typically between 20° and 55°. Each layer 150, 160 is used to sustain tensile loads and internal pressure. The tensile armour layers 150, 160 are counter-wound in pairs.

The flexible pipe body 100 also includes an outer sheath 170 which comprises a polymer layer used to protect the pipe body 100 against penetration of seawater and other external environments, corrosion, abrasion and mechanical damage. One or more layers 180 of insulation may also be included.

Each flexible pipe comprises at least one portion, sometimes referred to as a segment or section of pipe body 100 together with an end fitting located at least one end of the flexible pipe body. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

FIG. 2 illustrates a riser assembly 200 suitable for transporting production fluid such as oil and/or gas and/or water from a sub-sea location 210 to a floating facility 220. For example, in FIG. 2 the sub-sea location 210 is a connection to a sub-sea flow line 230. The flexible flow line comprises a flexible pipe, wholly or in part, resting on the sea floor or buried below the sea floor. The floating facility may be provided by a platform and/or buoy or, as illustrated in FIG. 2, a ship. The riser 200 is provided as a flexible riser, that is to say a flexible pipe connecting the ship to the sea floor installation. Alternatively the flexible pipe can be used as a jumper 240.

Whilst the embodiments described hereinafter relate to the loading, transportation and unloading of flexible pipe of this type it will be appreciated that certain embodiments of the present invention are more broadly applicable to the loading, transportation and unloading of one or more reels (or bobbins) of spoolable products in general such as mooring lines, communication lines, offloading hoses, coiled tube or any other elongate member which may or may not include a hollow bore.

FIGS. 3A and 3B illustrate how a flexible pipe 300, which comprises a segment of flexible pipe body and a first end fitting 301₁ and second end fitting 301₂, terminating each end, may be wound about a reel 302 for transportation. The reel 302 includes a first and second circular end arranged in a spaced apart relationship connected together by a central hub extending therebetween. As illustrated in FIG. 3A each circular end includes a generally circular rim 303 connected to a substantially hollow cylindrical hub 304 by spokes 305. It will be appreciated that as an alternative each end of the reel 302 may be solid from the hub to the rim region.

The flexible pipe 300 is wound around the central hub in a spooled arrangement much like cotton thread is wound around a cotton reel. A first end fitting 301₁ which terminates a first end region 306 of the flexible pipe 300 is held ready to be fed off the reel at a desired point in time. Many known methods are available for holding the end fitting 301₁ ready for unloading for example ropes and chains could be used, frames can be attached to the end fitting and in turn bolted onto a structure or other such practices.

The reel 302 is supported on two pairs 310 of rollers 311. Each pair 310 of rollers is spaced apart from the other in a substantially parallel manner so as to form a substantially rectangular or square arrangement with rollers being located in corners where a reel will rest in use.

As illustrated in FIG. 3B more clearly each roller 311 presents a substantially dished rim region around its circumferential edge and is free to rotate about a respective roller axis 312. The outer running surface 313 of the rim 303 of the reel 302 sits in the concave dished region of the rollers. The dished nature of the outer circumferential surface of the roller is such that any lateral motion of the reel along its longitudinal axis X is resisted so as to tend to keep the reel 302 firmly seated on the roller supports. In this sense the rollers act as a support for supporting a reel carrying a wound segment of flexible pipe.

The rim 303 of each reel end is kept in place by one or more reel rim guides. As illustrated in the embodiment shown in FIGS. 3A and 3B the reel rim guides may be formed as upstanding posts 320 formed approximately at each corner of a substantially H-shaped footprint presented by the reel. Each post 320 extends upwardly at or near to a corner region of a base plate 325.

The outer peripheral edge 326 of the base plate 325 is illustrated in FIGS. 3A and 3B as being of a substantially rectangular shape although aptly any shape which tessellates can be utilized. This improves the packing factor of reels in a vessel. It will be appreciated that according to certain other embodiments of the present invention the upwardly extending posts 320 and rollers 310 may be secured at desired locations directly to a deck or hold surface or wall of a sailing vessel. Cross struts 330 are aptly utilized to improve the rigidity and strength of the corner posts 320. The corner posts and reinforcing cross struts thus form a framework within which a reel will sit supported on rollers.

The corner posts are L-shaped and a part, parts or the whole of an L-shaped inner surface 340 is used as a reel rim guide to maintain the reel 302 at a desired location with respect to the four rollers 310. The inner surface 340 of the embodiment illustrated in FIGS. 3A and 3B carries wooden planks 341 against which the rim 303 of the reel can abut when a vessel moves causing the reel to move. The wooden planks 341 are aptly located on two internal side walls of the corner posts so that they constrain motion of a reel supported on the rollers in two corresponding directions. It will no doubt be appreciated that as an alternative an abutment member may be located on only one of the inner surfaces of the post and/or that the abutment elements themselves may be formed of any suitable material such as wood, metal and/or plastics or the like. Composite materials may also be used. The abutment elements may be L-shaped.

It will be appreciated that there are normally three motion conditions that have to be considered for an offshore transport and installation operation. These are (a) ocean transit where the vessel may be a considerable distance from a safe harbour and must withstand severe storm conditions, (b) local transit where the vessel may be closer to a safe harbour and would only be required to withstand a lesser storm condition and (c) during installation operations where the motion conditions are limited by other operations and where the reel is required to rotate. It is to be noted that generally speaking conditions (a) and (b) are considered as transport conditions in which a reel can be locked in place.

FIG. 4 illustrates how a reel carrying a wound flexible pipe may be loaded into the support framework illustrated in FIG. 3B. It will be appreciated that this operation can occur either prior to transport, in which case the reels are transported each in a respective frame, or at an installation site, which might be a shallow, deep or ultra deep water site in which case reels holding prespooled flexible pipe are stored in a vessel in some other manner and then loaded one by one into a frame arrangement for unspooling.

As illustrated in FIG. 4A the preloaded reel 302 is carried by a crane wire 400 into a desired location with respect to the four guide posts 320. The crane wire 401 has a wire hoop 401 at its end which hooks around a protruding region of the central hub 304. A similar hoop passes over a similar protruding hub region on a further side of the reel (not shown).

FIG. 4B illustrates how the reel 302 is lowered into the framework between the four posts and comes to rest on the rollers which thereafter support the weight of the reel. The corner posts and to some extent the rollers locate the reel at a desired location. In particular the rim 303 of the reel is located at a desired location with respect to the rollers by the support posts 320 and any abutment elements secured to an inside surface of those support posts. A curved guide 405 is optionally rigidly or movably secured to at least one of the corner posts 320 extending upwardly from the framework base 325. The base itself is bolted at a predetermined location onto the vessel deck 406.

During a loading step prior to transportation the spooled reel is located ready for transportation as per FIGS. 4A and 4B. Transportation on the vessel can then take place to a desired location as per steps (a) and/or (b) noted above and then during an installation process illustrated in FIG. 4C an end fitting 301₁ is pulled via a winch wire 410 to begin unspooling the wound flexible pipe from one of the reels. The curved guide 405 helps ensure that the flexible pipe comes off the reel in a desired manner and prevents overbending. The rollers are driven to help unspool the flexible pipe.

FIG. 5 illustrates how multiple reels may be loaded into a vessel and thereafter transported in a space-efficient manner. To some extent FIG. 5 also helps indicate how certain parts of the framework used for transporting and/or installing flexible pipe may be shared. In this sense FIG. 5 illustrates how the upstanding posts may share a large common base 525. Corner posts in adjacent support frameworks could also be shared. Similarly rows of rollers bridging two or more reels can be used with shared motor drives providing power to selectively rotate reels.

As illustrated in FIG. 5 reels may be loaded into one, two or more, all or less than all support frameworks in a vessel.

During transport each spooled segment of flexible pipe may be locked in place with chains, wires, ropes and/or wedges or the like. Where multiple reels are transported in a system packing may be inserted between the reels themselves to prevent excessive movement. As noted in FIG. 5 where a number of spools are to be transported or operated together the adjoining structure may be shared by adjacent frames.

It is also to be noted that each frame may be provided optionally with a curved guide 405 of the type illustrated in FIG. 4B. These may be arranged in a fixed position or arranged to move laterally across the reel to control the position of the flexible pipe as it is spooled off or onto a reel. Where a number of frames are arranged in group as per FIG. 5 the curved plates may be arranged to serve more than one reel.

Where the framework of corner posts and rollers are to be installed in the hold of a ship it is possible to use the ship hull as part of the support structure. In this case the framework may be reduced to a series of bulkheads or transverse frames, walls or bars with roller bases arranged between them.

FIG. 6A and FIG. 6B illustrate a side view and plan view respectively of a vessel 600 which may be utilized to transport reels of spooled flexible pipe from a first location to a further location. The vessel 600 has a deck surface 601 on which ancillary equipment utilized during a loading and/or installation process may be secured. As illustrated in FIG. 6B three spooled reels of flexible pipe may be transported in the hold of the vessel 600. Other numbers are of course possible. FIG. 6A illustrates a section through the ship's hold and illustrates how reels 302 may be supported on respective rollers. One or more cranes/winches (not shown) may also be included on a vessel.

As illustrated in FIG. 6A, two rollers 311 form a pair 310 of rollers and two pairs of rollers are provided to support each reel. The hold of the vessel has a fore and aft side wall 602, 603 and port and starboard side walls 604, 605. Wooden abutment planks 641 are secured at appropriate positions to the side walls to guide the rims 303 of respective reels so as to keep those reels at a desired position with respect to the rollers. In this sense it will be appreciated that the side walls forming the hold of a vessel can be used instead of upright posts in the corners of the footprint of the reels.

Support walls 642 extend between the port and starboard side walls and provide hull integrity as well as providing supports for further wooden abutment elements at appropriate positions with respect to the H-shaped footprint of each of the reels. Abutment element carriers extend from the wall at central locations to duly locate abutment elements between adjacent reels. Likewise abutment element arms extend off the fore and aft side walls between reels.

On the top of the intermediate bulkhead support walls 642 which form cross walls guide funnels 650 are located. These can be used to support flexible pipe as it is unspooled from a particular reel so as to help locate the flexible pipe in a desired pathway and to prevent overbending. Lateral bend shoes 651 are provided at desired locations for similar reasons. Towards the aft region of the vessel a caterpillar tensioner 652 is located to help draw flexible pipe from a reel during an installation process. A lay shoot 653 is located at the rear of the vessel so as to prevent overbending of flexible pipe as it is unwound from the vessel and deposited into the sea. The forward bulkhead 602, aft bulkhead 603 and intermediate bulkhead 642 help maintain hull integrity as well as provide support surfaces to help guide the reels into desired locations with respect to the rollers. The apparatus provided can be used for capturing, supporting and driving reels of tubular products while aboard a vessel in motion. The apparatus comprises a support frame, means for constraining a reel while in the frame, guides to locate the reel within the frame, dedicated under rollers to drive the reels and clear top access allowing unencumbered loading and removal of reels. The apparatus can be a self contained unit which may itself be mobile and capable of being transported or may form part of the vessel's bull walks taking advantage of existing structures. The under rollers may all be driven so that the rollers not only carry the weight of the bobbin but also supply a force to rotate the reel or one or more of the whole arrangement of rollers may be driven. The rollers may comprise hydraulic, pneumatic or electronic mechanisms to apply and remove contact from the reel.

FIG. 7 illustrates an alternative embodiment of the present invention which can be used for transporting and/or unloading and/or installing a wound length of flexible pipe. As illustrated in FIG. 3A the embodiment illustrated in FIG. 7 illustrates how a flexible pipe 300 which comprises a segment of flexible pipe body and a first end fitting 301₁ and second end fitting 301₂ terminating each end, may be wound about a reel 302 for transportation. Each circular end of the reel 302 includes a rim 303 connected to a substantially hollow cylindrical hub 304. Also like the embodiment shown in FIG. 3A the rim 303 of each reel end is kept in place by one or more reel rim guides. These are formed as upstanding posts 320 formed approximately at each corner of a substantially H-shaped footprint presented by the wheel. The posts extend upwardly at respective corner regions of a base plate 325. Cross struts 330 are aptly utilised to improve the rigidity and strength of the corner posts 320. The corner posts and reinforcing cross struts thus form a framework within which a reel will sit. The base plate and corner posts themselves form a mobile construction which may be bolted to a vessel at desired locations. Alternatively, as per the embodiment described with respect to FIG. 3A and FIG. 3B, the corner posts and cross struts may extend from a deck or hold surface of a vessel.

An arcuate support having an arcuate support surface 700 is provided to support a reel member. The arcuate support surface 700 illustrated in FIG. 7 is shown extended upwardly away from a surface 701 of the base plate. It will be understood that alternatively a concave region may be formed in the upper surface 701 of the base plate so that the reel is supported below the upper surface 701.

Two pairs 710 of rollers 711 are pivotably provided adjacent to the arcuate support surface 700. In a transport mode of operation the rollers 711 are held by a hydraulic ram 712 in a position so that the reel 302 is supported on the arcuate surface 700. As the reel is transported the reel is held in place by the friction between the arcuate surface 701 and the reel rim 303 and the abutment of parts of the upright posts 320 or abutment elements 341 (not shown). Other fastening elements such as chains, ropes, wedges or the like may also be used.

When at a desired location the hydraulic rams 712 are driven to move the rollers 711 upwardly. This lifts the reel rim 303 away from the arcuate surface 700 so that the reel then rests upon four rollers as per the embodiment shown in FIGS. 3A and 3B. One or more of the rollers is a driven roller which can be rotated so as to cause the reel itself to rotate during an unspooling or spooling mode of operation. The roller elements 711 which may or may not be driven roller elements are reversibly extendable from the disengaged position in which the reel member is supported on the arcuate surface of the arcuate reel support to an engaged position in which the reel member is supported by the plurality of driven roller elements out of contact with the arcuate surface. It will be appreciated that according to certain other aspects of the present invention one pair of roller elements may be fixed in position with a further pair being reversibly drivable from a disengaged position to an engaged position.

FIG. 7 thus illustrates an alternative to the static roller base described with respect to FIGS. 3A and 3B. The rollers are recessed below the level of a curved cradle that supports the reel in a transport mode. Hydraulic or pneumatic jacks or other such lifting/lowering equipment then lift the rollers to engage the reel during operation. In the event of a power failure the reel is automatically lowered back onto the curved track under its own weight to prevent further rotation. Aptly the rollers are hydraulically or mechanically spring loaded to provide a soft landing for the reel during loading.

FIG. 8 illustrates an alternative embodiment of the present invention in many ways similar to that shown in FIG. 7. In FIG. 8, in addition to the recessed rollers which are able to move from an engaged to disengaged position in a reversible manner, one or more of the reel rim guides previously described as being located on one or more inner surface of the corner posts is replaced by a spring loaded roller 800. The roller 800 is supported at an upper region of a corner post 801 and is arranged to rotate about a respective axis Y. The roller is supported between horns 802 which extend from an arm 803 which pivots about a pivot point Z. A spring 804 biases the running rim 805 of the spring loaded roller into running engagement with the rim 303 of the reel. It will be appreciated that other biasing elements/mechanisms can be utilised according to further embodiments of the present invention. An advantage of using one or more of these vertical reel rim guides which are resiliently loaded in some manner is that minor irregularities in the reel diameter and roundness are accommodated. This helps reduce friction during loading and unloading and reduces the noise from contact between the rim and vertical guides.

FIG. 9 illustrates a still further embodiment of the present invention in which the posts and corresponding vertical reel rim guides are replaced with rollers and these rollers are themselves connected to main drive rollers on a common pivoting arm such that the weight of the reel serves to clamp the reel in place.

As illustrated in FIG. 9 two pairs 910 of rollers (only one roller of each pair shown in FIG. 9) is used as a support member for supporting a reel 302 carrying a wound flexible pipe. The rollers 911 may each be driven or one, two or more or all of the rollers are driven. In this way when a reel 302 is supported on the driven rollers the rim 303 of the reel 302 may be caused to rotate by driving the rollers in a coordinated fashion. Each of the lower rollers 911 is secured between substantially L-shaped parallel spaced apart arms 915. The lower rollers 911 can rotate about a respective axis between respective spaced apart substantially parallel L-shaped arms 915. A further pair of rollers 916 (only one roller of each pair shown in FIG. 9) is rotatably held between the substantially L-shaped arms 915 at a further end region thereof. As illustrated in FIG. 9 the arms 915 provides a rigid structure for duly locating rollers 911 and 916 at a spaced apart relationship with respect to each other. Rather than L-shaped rollers the arms could of course be substantially triangular in shape or some other such shape. The arms 915 pivot about an axis M which is provided by an axle 917 extending between upwardly extending flanges 920 which extend upwardly from the base plate 325 (or vessel surface if no base plate is utilised). A locking pin 921 can be duly located to lock the arms carrying the rollers in a fixed relationship with respect to the reel and/or base plate. This is particularly convenient subsequent to loading of the reel during a transport phase.

The upper rollers 916 are aptly idle rollers which are connected to the main drive rollers on a common pivoting arm such that the weight of the reel serves to clamp the reel into place. In this way the upper idle rollers act as reel rim guides for locating the reel at a desired location with respect to the lower rollers 911 which act as a support for the reel. As a reel is brought to rest on the lower rollers the upper rollers are brought together in a clamping action to help grip the reel.

Spring dampers 930 hold the arms 915 slightly away from the upper surface of the base 325 when a reel is not in place. When a reel 302 is winched into position onto the lower rollers 911 the spring dampers provide some cushioning to reduce the impact loads on the rollers.

Certain embodiments of the present invention increase the efficiency of reel storage aboard an ocean going vessel by decreasing a footprint of the system required to constrain the reels and rotate them. Certain embodiments of the present invention constrain the reels under dynamic motions of the vessel. Certain embodiments of the present invention constrain the reels as flexible pipe product is removed from the reels. Certain embodiments of the present invention provide power to a reel and/or allow for a controlled rotation as flexible pipe product is removed from a reel. Certain embodiments of the present invention allow quick removal and replacement of reels. Certain embodiments of the present invention efficiently distribute the dynamic and static load provided by a reel and product to the load bearing structures of a vessel.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. Apparatus for transporting and/or unloading and/or installing a flexible pipe, comprising:
at least one support member for supporting a reel member carrying a wound flexible pipe: and
a plurality of reel rim guide elements for locating the reel member at a desired location with respect to the support member.

2. The apparatus as claimed in claim 1 wherein the support member comprises an arcuate reel support comprising an arcuate reel support surface.

3. The apparatus as claimed in claim 2, further comprising:
a plurality of roller elements at least one roller element comprising a driven roller element.

4. The apparatus as claimed in claim 3, further comprising:
the driven roller elements are reversibly extendible from a disengaged position in which the reel member is supported on the arcuate surface of the arcuate reel support to an engaged position in which the reel member is supported by the plurality of driven roller elements, out of contact with the arcuate surface.

5. The apparatus as claimed in claim 1, wherein the support member comprises a plurality of roller elements, at least one of the roller elements comprising a driven roller element.

6. The apparatus as claimed in claim 1, further comprising:
each rim guide element comprises an abutment element supported by a respective upstanding post element located at a corner region associated with a footprint of the reel member.

7. The apparatus as claimed in claim 6, further comprising:
each post element is substantially L-shaped and supports abutment elements on two internal side walls thereof to constrain motion of a reel member supported by said support member in two corresponding directions.

8. The apparatus as claimed in claim 1, further comprising:
the rim guide elements comprise spring loaded roller guides each supported at a top region of a respective one upstanding post element located at a corner region associated with a footprint of the reel member.

9. The apparatus as claimed in claim 1, further comprising:
the at least one support member comprises a plurality of arcuate or substantially L-shaped pivot arms each arranged to pivot about a respective pivot point and carrying at a first respective end region thereof a support roller element.

10. The apparatus as claimed in claim 9, further comprising:
a spring damper element for biasing each pivoting arm in a desired position.

11. The apparatus as claimed in claim 9, further comprising:
a locking pin element for locking each arm in a desired position.

12. The apparatus as claimed in claim 9, further comprising:
the plurality of reel rim guide elements comprise a plurality of guide roller elements each carried at a respective further end region of the pivot arms.

13. The apparatus as claimed in claim 9 wherein at least one support roller element is a driven roller element.

14. The apparatus as claimed in claim 1, further comprising:
a base plate securable to a deck region of a vessel.

15. The apparatus as claimed in claim 1, further comprising
a curved bend shoe arranged to guide flexible pipe exiting the reel member.

16. The apparatus as claimed in claim 1 wherein the reel member comprises a first and further substantially circular end member arranged in a substantially parallel spaced apart configuration and connected together via a hub region so as to provide a substantially H-shaped footprint prior to flexible pipe being wound onto the reel member.

17. A method of transporting a flexible pipe, comprising the steps of:
on a deck or in a hold of a vessel, supporting a reel member carrying a wound flexible pipe with at least one support member; and
as the vessel moves, maintaining the reel member at a desired location with respect to the support member via a plurality of reel rim guide elements.

18. The method as claimed in claim 17, further comprising the steps of:
supporting the reel member on a plurality of roller elements, said roller elements comprising said support member, at least one roller element comprising a driven roller element, and said plurality of roller elements being spaced apart in a substantially square or rectangular configuration so as to support reel rims of the reel member.

19. The method as claimed in claim 17, further comprising the steps of:
maintaining the reel member at a desired location via abutment elements on two internal side walls of upstanding post elements located at corner regions associated with a footprint of the reel member, said abutment elements constraining motion of a reel member supported by said support member in two corresponding directions.

20. The method as claimed in claim 17, further comprising the steps of:
locating the reel member via spring loaded roller elements on upstanding post elements located at corner regions associated with a footprint of the reel member, said spring loaded roller elements constraining motion of a reel member supported by said support member in two corresponding directions.

21. The method as claimed in claim 17, further comprising the steps of:
locating the reel member via idled roller elements each carried at an end region of a respective arcuate or substantially L-shaped pivot arm arranged to pivot about a respective pivot point.

22. A method of installing a flexible pipe, comprising the steps of:
rotating a rim of a reel member carrying a wound flexible pipe by driving at least one driven roller element supporting the reeled member.

23. The method as claimed in claim 22, further comprising the steps of:
prior to rotating the rim, lifting the reel member away from an arcuate wheel support surface with a plurality of roller elements, at least one of said roller elements comprising said at least one driven roller element.

24. The method as claimed in claim 22, further comprising the steps of:
guiding the flexible pipe as it is unwound from the reel member via a curved bend shoe supported on an upstanding post element located at a corner region associated with a footprint of the reel member.

25. (canceled)

26. (canceled)
